(19) United States
(12) Patent Application Publication
(10) Pub. No.: US 2026/0274619 A1
(43) Pub. Date: Sep. 17, 2026

(54) DIFFERENTIAL MOVING DEVICE

(71) Applicant: TSUBAKIMOTO CHAIN CO., Osaka-shi, Osaka (JP)

(72) Inventor: Tsutomu Tokumoto, Osaka-shi, Osaka (JP)

(73) Assignee: TSUBAKIMOTO CHAIN CO., Osaka-shi, Osaka (JP)

(21) Appl. No.: 19/473,608

(22) PCT Filed: Jul. 24, 2023
(86) PCT No.: PCT/JP2023/026938

§ 371 Date: Oct. 8, 2025

(30) Foreign Application Priority Data
Apr. 11, 2023 (JP) 2023-064192

(51) Int. Cl. B66C 11/18; B66C 11/20

(52) U.S. Cl. CPC B66C 11/18; B66C 11/20

(57) ABSTRACT

A differential moving device includes: an endless member constituting an endless path, the endless member including: a first path segment disposed inside; a second path segment disposed outside; and a connection path segment connecting the first path segment and the second path segment; a first driving roller engaged to the first path segment; a second driving roller engaged to the second path segment; a first driving motor that rotationally drives the first driving roller; a second driving motor that rotationally drives the second driving roller; a control unit that controls the first driving motor and the second driving motor; and a movable pulley unit including: a movable pulley that is engaged to the connection path segment and linearly moves along a first axial direction and/or rotates with movement of the first path segment and the second path segment; a first moving member that moves along the first axial direction with linear movement of the movable pulley; and a second moving member that is held by the first moving member and moves with rotation of the movable pulley.

### TECHNICAL FIELD

The present disclosure relates to a differential moving device.

### BACKGROUND ART

Conventionally, as a differential moving device, there is a differential moving device using an H-shaped frame as a frame for holding a belt or a roller (see, for example, Patent Document 1).

### PRIOR ART DOCUMENT

### Patent Document

Patent Document 1: JP-A-S58-59777

### SUMMARY OF THE INVENTION

### Problems to be Solved by the Invention

However, since the H-shaped frame is used, there is an issue that the size of the moving device tends to be large.

Therefore, an object of the present disclosure is to solve the above issue and to provide a differential moving device capable of achieving downsizing.

### Solutions to the Problems

In order to achieve the above object, a differential moving device according to the present disclosure includes: an endless member constituting an endless path, the endless member including: first path segment disposed inside; a second path segment. disposed outside; and a connection path segment connecting the first path segment and the second path segment; a first driving roller engaged to the first path segment; a second driving roller engaged to the second path segment; a first driving motor that rotationally drives the first driving roller; a second driving motor that rotationally drives the second driving roller; a control unit that controls the first driving motor and the second driving motor; and a movable pulley unit engaged to the connection path segment, the movable pulley unit including: a movable pulley that linearly moves along a first axial direction and/or rotates with movement of the first path segment and the second path segment; a first moving member that moves along the first axial direction with linear movement of the movable pulley; and a second moving member that is held by the first moving member and moves with rotation of the movable pulley.

### Effects of the Invention

According to the present disclosure, downsizing can be achieved.

### BRIEF DESCRIPTION OF THE DRAWINGS

FIG. 1 is a perspective view of a differential moving device according to a first embodiment.

FIG. 2 is the perspective view of the differential moving device according to the first embodiment.

FIG. 3 is a perspective view of the differential moving device according to the first embodiment (a first moving block is shown by a broken line).

FIG. 4 is a front view of the differential moving device according to the first embodiment (the first moving block is shown by a broken line).

FIG. 5 is a perspective view of the first moving block according to the first embodiment.

FIG. 6 is a perspective view of the first moving block according to the first embodiment.

FIG. 7 is a side view of the first moving block according to the first embodiment.

FIG. 8 is a side view of the first moving block according to the first embodiment.

FIG. 9A is a schematic front view for describing an operation of the differential moving device according to the first embodiment.

FIG. 9B is a schematic front view for describing an operation of the differential moving device according to the first embodiment.

FIG. 9C is a schematic front view for describing an operation of the differential moving device according to the first embodiment.

FIG. 9D is a schematic front view for describing an operation of the differential moving device according to the first embodiment.

FIG. 10 is a rough front view of the differential moving device according to the first embodiment.

FIG. 11 is a rough front view of a differential moving device according to a first variation.

FIG. 12 is a rough front view of a differential moving device according to a second variation.

FIG. 13 is a rough front view of a differential moving device according to a third variation.

FIG. 14 is a rough front view of a differential moving device according to a fourth variation.

FIG. 15 is a rough bottom view of the differential moving device illustrated in FIG. 14.

FIG. 16 is a rough front view of a differential moving device according to a fifth variation.

FIG. 17 is a rough bottom view of the differential moving device illustrated in FIG. 16.

FIG. 18 is a rough front view of a differential moving device according to a sixth variation.

FIG. 19 is a front view of a differential moving device according to a second embodiment.

FIG. 20 is the perspective view of the differential moving device according to the second embodiment.

FIG. 21 is the perspective view of a differential moving device according to a third embodiment.

FIG. 22 is the perspective view of a differential moving device according to a fourth embodiment.

FIG. 23 is the perspective view of the differential moving device according to the fourth embodiment. FIG. 24 is a perspective view obtained by performing cutting away on

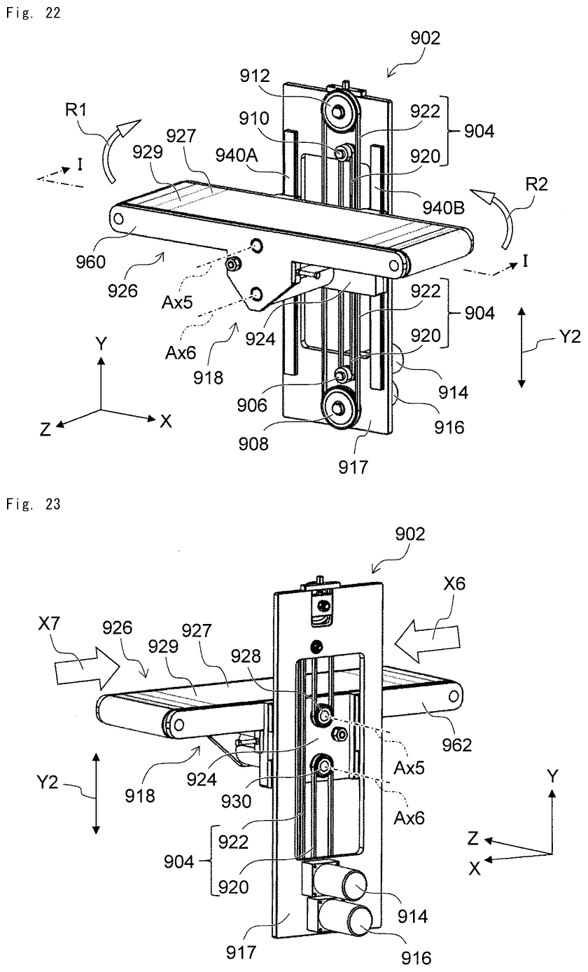

the differential moving device of FIG. 22 along an I-I cross-section.

### DETAILED DESCRIPTION

According to a first aspect of the present disclosure, there is provided a differential moving device that includes: an endless member constituting an endless path, the endless member including: a first path segment disposed inside; a second path segment disposed outside; and a connection path segment connecting the first path segment and the second h segment;: first driving roller engaged to the first path segment; a second driving roller engaged to the second path segment; a first driving motor that rotationally drives the first driving roller; a second driving motor that rotationally drives the second driving roller; a control unit that controls the first driving motor and the second driving motor; and a movable pulley unit including: a movable pulley that is engaged to the connection path segment and linearly moves along a first axial direction and/or rotates with movement of the first path segment and the second path segment; a first moving member that moves along the first axial direction with linear movement of the movable pulley; and a second moving member that is held by the first moving member and moves with rotation of the movable pulley.

According to a second aspect of the present disclosure, there is provided the differential moving device according to the first aspect, in which the second moving member linearly moves along a second axial direction with the rotation of the movable pulley.

According to a third aspect of the present disclosure, there is provided the differential moving device according to the second aspect, in which the first axial direction and the second axial direction extend in directions intersecting each other.

According to a fourth aspect of the present disclosure, there is provided the differential moving device according to the second aspect, in which the first axial direction and the second axial direction extend in directions parallel to each other.

According to a fifth aspect of the present disclosure, there is provided the differential moving device according to the first aspect, in which the second moving member rotationally moves with the rotation of the movable pulley.

According to a sixth aspect of the present disclosure, there is provided the differential moving device according to the fifth aspect, in which the second moving member is a belt conveyor having a belt that rotates with the rotation of the movable pulley.

According to a seventh aspect of the present disclosure, there is provided the differential moving device according to any one of the first to sixth aspects, in which (i) the connection path segment includes: a first connection path segment that connects a first end of the first path segment and a first end of the second path segment; and a second connection path segment that connects a second end of the first path segment and a second end of the second path segment, (ii) the movable pulley includes: a first movable pulley engaged to the first connection path segment; and a second movable pulley engaged to the second connection path segment, and (iii) the first movable pulley and the second movable pulley integrally move along the first axial direction.

According to an eighth aspect of the present disclosure, there is provided the differential moving device according to the seventh aspect, in which the second moving member is engaged with any one of the first movable pulley and the second movable pulley.

According to a ninth aspect of the present disclosure, there is provided the differential moving device according to any one of the first to eighth aspects, and the differential moving device further includes a support member that supports the first driving roller and the second driving roller each in a rotatable state.

According to a tenth aspect of the present disclosure, there is provided the differential moving device according to the ninth aspect, in which the support member includes a first guide portion that guides the movement of the first moving member along the first axial direction.

According to an eleventh aspect of the present disclosure, there is provided the differential moving device according to the tenth aspect, in which the first moving member includes a second guide portion that guides the movement of the second moving member along the second axial direction.

According to a twelfth aspect of the present disclosure, there is provided the differential moving device according to any one of the first to eleventh aspects, in which the first driving roller is disposed inside the first path segment, and the second driving roller is disposed inside the second path segment.

According to a thirteenth aspect of the present disclosure, there is provided the differential moving device according to any one of the first to twelfth aspects, in which the endless member includes: a first main surface to which the first driving roller is engaged; and a second main surface to which the second driving roller is engaged.

According to a fourteenth aspect of the present disclosure, there is provided the differential moving device according to any one of the first to thirteenth aspects, in which the first driving roller and the second driving roller are disposed on a first side with respect to the movable pulley unit.

According to a fifteenth aspect of the present disclosure, there is provided the differential moving device according to any one of the first to fourteenth aspects, in which the first driving roller is disposed on a first side with respect to the movable pulley unit. and the second driving roller is disposed on a second side with respect to the movable pulley unit.

According to a sixteenth aspect of the present disclosure, there is provided the differential moving device according to any one of the first to fifteenth aspects, and the differential moving device includes: a first driven roller engaged to the first path segment; and a second driven roller engaged to the second path segment.

According to a seventeenth aspect of the present disclosure, there is provided the differential moving device according to the sixteenth aspect, in which the first driving roller and the first driven roller are disposed inside the first path segment, and the second driving roller and the second driven roller are disposed inside the second path segment.

According to an eighteenth aspect of the present disclosure, there is provided the differential moving device according to any one of the first to seventeenth aspects, in which the endless member is at least one of a belt, a chain, a wire, a cable, a rope, and a thread.

Hereinafter, exemplary embodiments of a differential moving device according to the present disclosure will be described with reference to the accompanying drawings. The present disclosure is not limited to the specific configurations of the following embodiments, and configurations based on similar technical ideas are included in the present disclosure.

### First Embodiment

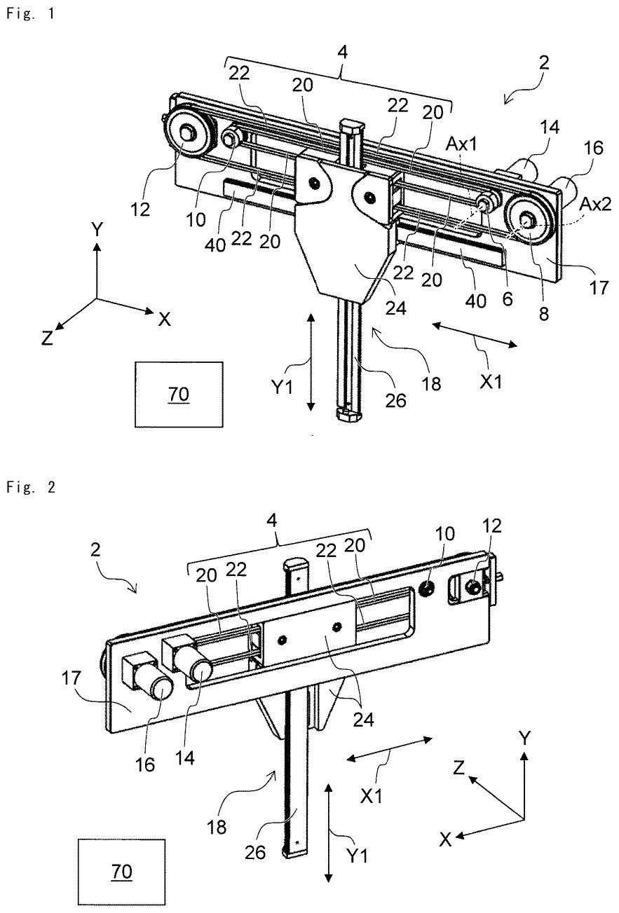

First, a differential moving device according to a first embodiment of the present disclosure will be described with reference to FIGS. 1 to 10.

FIGS. 1 and 2 are each a perspective view of a differential moving device 2 according to the first embodiment.

The differential moving device 2 illustrated in FIGS. 1 and 2 is a moving device of a differential (differential device), and functions as a differential two-axis robot when a movable pulley unit 18 to be described later moves along two axes. The differential moving device 2 of the first embodiment is a two-axis orthogonal robot movable in an X direction and a Y direction orthogonal to each other, and does not have a function of moving in a Z direction orthogonal to both the X direction and the Y direction.

The differential moving device 2 can be used not only for a two-axis orthogonal robot but also for various other applications. For example, the differential moving device 2 may be applied to a three-dimensional warehouse, an elevator, a cargo handling device, industrial equipment, a construction machine, harbor equipment, an agricultural machine, a processing machine, a plotter, aerospace equipment, radiation res ant equipment, low temperature resistant equipment, and medical equipment.

The differential moving device 2 illustrated in FIGS. 1 and 2 includes an endless member 4 as a driving cable, a first driving roller 6, a second driving roller 8, a first driven roller 10, a second driven roller 12, a first driving motor 14, a second driving motor 16, a supporting block 17, a movable pulley unit 18, and a control unit 70.

The endless member 4 is a member constituting an endless path (circulating path) and is a driving cable driven by the driving rollers 6 and 8. Any type of member may be used as the endless member 4 as long as the driving rollers 6 and 8 are engaged in a drivable manner, and for example, a belt, a chain, a wire, a cable, a rope, or a thread may be used.

As the endless member 4 of the first embodiment, a member (for example, a double-sided belt, a chain, or the like) whose two main surfaces can be engaged with the driving rollers is used. The first driving roller 6 is engaged with a first main surface of the endless member 4, and the second driving roller 8 is engaged with a second main surface of the endless member 4.

The endless member 4 includes a first path segment 20 and a second path segment 22. The first path segment 20 is a portion disposed inside the second path segment 22, and the second path segment 22 is a portion disposed outside the first path segment 20. The first path segment 20 may be referred to as an “inner loop”, and the second path segment 22 may be referred to as an “outer loop”.

The first driving roller 6 and the second driving roller 8 are each a roller for rotating the endless member 4. The first driving roller 6 is engaged to the first path segment 20 of the endless member 4, and the second driving roller & is engaged to the second path segment 22 of the endless member 4.

The first driving roller 6 is rotationally driven by the first driving motor 14 so as to rotate about a first rotation axis Ax1 (FIG. 1). The second driving roller 8 is rotationally driven by the second driving motor 16 so as to rotate about a second rotation axis Ax2.

In the first embodiment 1, the driving motors 14 and 16 are respectively connected directly to the driving rollers 6 and 8 without an indirect member such as a belt interposed therebetween.

The first driven roller 10 and the second driven roller 12 are each a roller that rotates following the movement of the endless member 4. The first driven roller 10 is engaged to the first path segment 20, and the second driven roller 12 is engaged to the second path segment 22.

The supporting block 17 is a block-shaped support member that supports components of the differential moving device 2. The supporting block 17 supports the first driving roller 6, the second driving roller 8, the first driven roller 10, the second driven roller 12, the first driving motor 14, and the second driving motor 16 each in an operable state. The endless member 4 and the movable pulley unit 18 are indirectly supported by the supporting block 17.

The supporting block 17 further includes a first guide portion 40 for guiding a sliding movement of the movable pulley unit 18. The first guide portion 40 extends along a first axial direction X1 and guides the sliding movement of the movable pulley unit 18 along the first axial direction X1.

The movable pulley unit 18 is a unit having a movable pulley that linearly moves and/or rotates with the movement of the endless member 4. The movable pulley unit 18 is also referred to as a “moving carriage”.

The movable pulley unit 18 includes a first moving block 24 and a second moving block 26.

The first moving block 24 is a block-shaped moving member relatively movable with respect to the supporting block 17, is engaged with the first guide portion 40 described above, and slidingly moves along the first axial direction X1 extending in the X direction.

The second moving block 26 is a block-shaped moving member relatively movable with respect to the first moving block 24, and is held by the first moving block 24 to be slidingly movable along a second axial direction Y1 extending in the Y direction.

In the first embodiment, the first axial direction X1 and the second axial direction Y1 are orthogonal to each other.

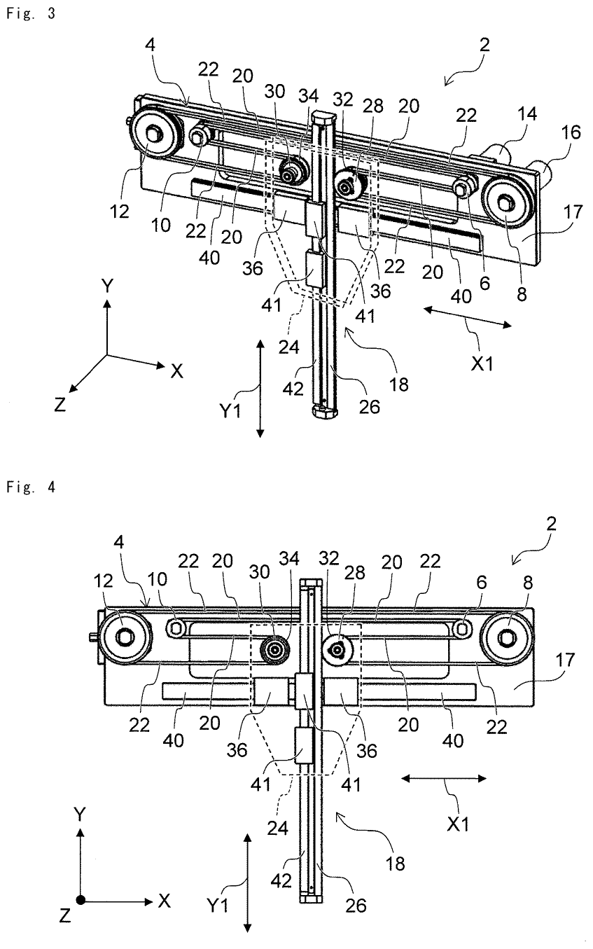

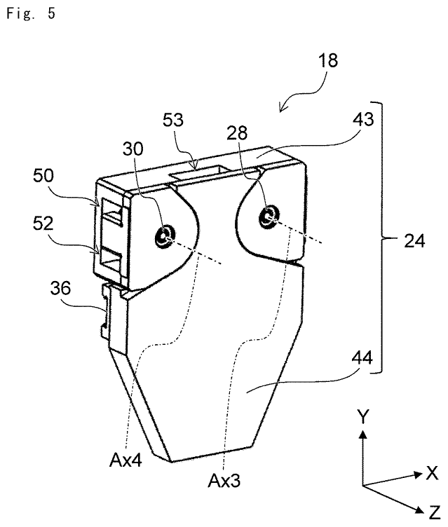

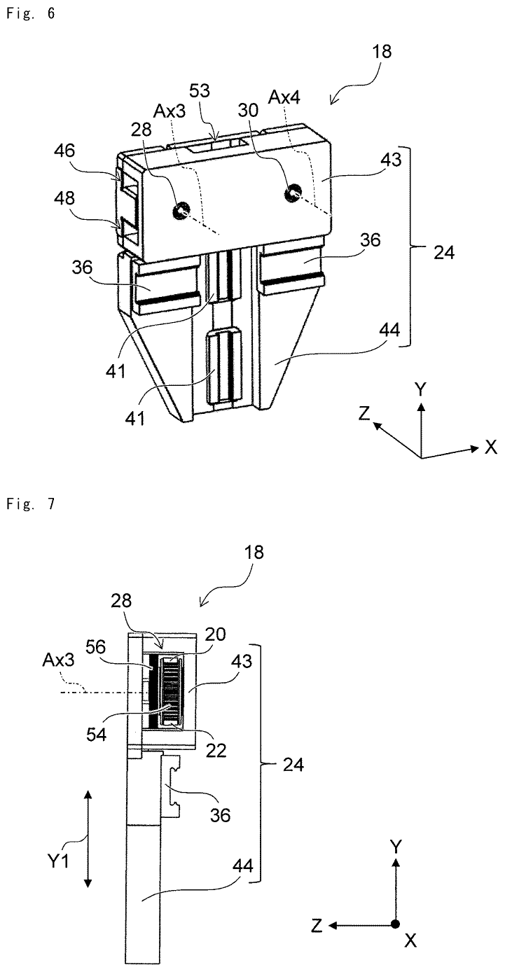

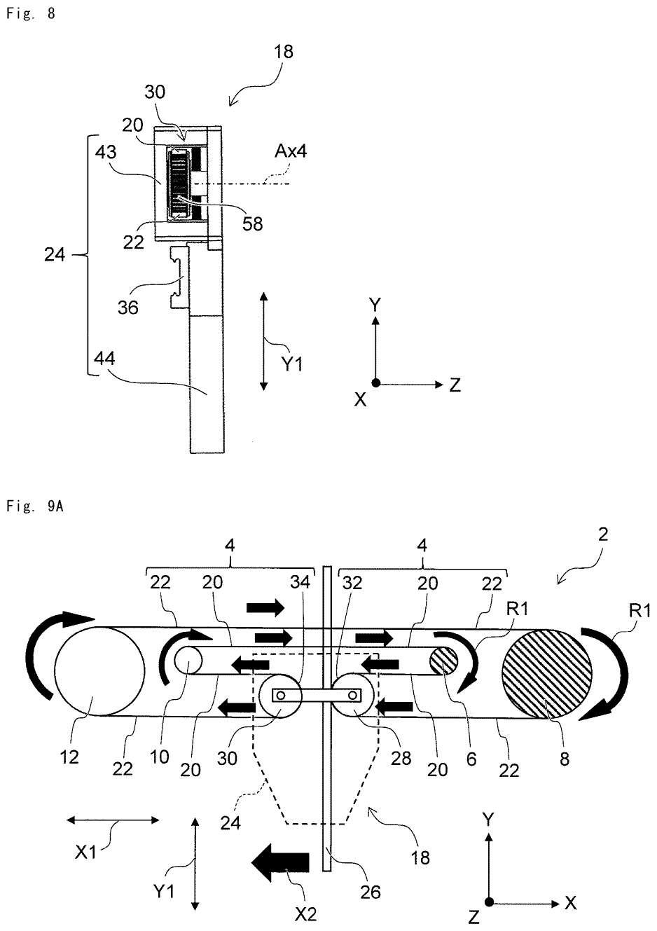

FIGS. 3 and 4 are respectively a perspective view and a front view illustrating the first moving block 24 of the movable pulley unit 18 by broken lines. FIGS. 5 and 6 are each a perspective view of the first moving block 24, and FIGS. 7 and 8 are each a side view of the first moving block 24. In FIGS. 7 and 8, some members are not illustrated so that an internal structure of the first moving block 24 can be visually recognized.

As illustrated in FIGS. 3 and 4, the movable pulley unit 18 includes a first movable pulley 28 and a second movable pulley 30 as movable pulleys engaged to the endless member 4.

The first movable pulley 28 is a movable pulley engaged to a first connection path segment 32 that connects a first end of the first path segment 20 and a first end of the second path segment 22. The second movable pulley 30 is a movable pulley engaged to a second connection path segment 34 that connects a second end of the first path segment 20 and a second end of the second path segment 22.

In the endless member 4, the first path segment 20, the second path segment 22, the first connection path segment 32, and the second connection path segment 34 form an endless circulating path.

The first movable pulley 28 and the second movable pulley 30 are integrally held in a rotatable state by the first moving block 24.

As illustrated in FIGS. 3, 4, and 6, the first moving block 24 includes first sliders 36. The first sliders 36 are portions engaged with the first guide portion 40 of the supporting block 17 described above, and the first sliders 36 move along the guide portion 40, so that the first moving block 24 slidingly moves along the first axial direction X1.

The first moving block 24 further includes second guide portions 41. The second guide portions 41 are portions for guiding a sliding movement in the second axial direction Y1 by the second moving block 26. A second slider 42 of the second moving block 26 is engaged with the second guide portions 41, and the second slider 42 moves along the second guide portions 41, so that the second moving block 26 slidingly moves along the second axial direction Y1.

As illustrated in FIGS. 5 and 6, the first moving block 24 includes a first member 43 and a second member 44.

The first member 43 is a block portion constituting a part of the first moving block 24, is disposed, for example, above the second member 44, and incorporates therein the first movable pulley 28 and the second movable pulley 30 each in a rotatable state.

The first member 43 is provided with a plurality of openings. Specifically, there are provided with openings 46 and 48 (FIG. 6) and openings 50 and 52 (FIG. 5) as openings through which the endless member 4 passes. Furthermore, an opening 53 is provided as an opening through which the second moving block 26 passes.

The openings 46 and 48 illustrated in FIG. 6 are respectively openings through which the path segments 20 and 22 pass. The first end of the first path segment 20 put through the opening 46 and the first end of the second path segment 22 put through the opening 48 are connected by the first connection path segment 32 (FIGS. 3 and 4) inside the first moving block 24.

The openings 50 and 52 illustrated in FIG. 5 are respectively openings through which the path segments 20 and 22 pass. The second end of the first path segment 20 put through the opening 50 and the second end of the second path segment 22 put through the opening 52 are connected by the second connection path segment 34 (FIGS. 3 and 4) inside the first moving block 24.

The second member 44 is a block portion constituting a part of the first moving block 24, is disposed, for example, below the first member 43, and includes the first slider portions 36 and second guide portions 41 as illustrated in FIG. 6. The first sliders 36 each have a recess extending in the X direction, and the second guide portions 41 each have a recess extending in the Y direction. In the first embodiment, the two first slider portions 36 and the two second guide portions 41 are each provided at interval, but the numbers and shapes are not limited thereto.

As illustrated in FIG. 7, the first movable pulley 28 incorporated in the first member 43 includes at least two gears 54 and 56. The gears 54 and 56 are gears configured so as to rotate integrally about a third rotation axis Ax3, and are disposed at interval in the direction in which the third rotation axis Ax3 extends.

The gear 54 is engaged to the first connection path segment 32 (FIGS. 3 and 4) connecting the path segments 20 and 22, and rotates with the movement of the endless member 4. The gear 56 is configured to integrally rotate in accordance with the rotation of the gear 54, and is engaged to the second moving member 26 (not illustrated).

When the gear 54 and the gear 56 integrally rotate in accordance with the movement of the endless member 4, the second moving block 26 engaged to the gear 56 slidingly moves along the second axial direction Y1. The second moving block 26 and the gear 56 of the first embodiment are configured in a rack and pinion arrangement.

As illustrated in FIG. 8, the second movable pulley 30 includes a gear 58. The gear 58 is configured to rotate about a fourth rotation axis Ax4. The gear 58 is engaged to the second connection path segment 34 connecting the path segments 20 and 22, and rotates with the movement of the endless member 4.

The second moving block 26 is not engaged with the second movable pulley 30 and is engaged with only the first movable pulley 28, and slidingly moves along the second axial direction Y1 in accordance with the rotation of the first movable pulley 28. As a result, the rotations of the first movable pulley 28 and the second movable pulley 30 do not interfere with each other, so that the second moving block 26 can be slidingly moved in a desired direction.

With reference again to FIGS. 1 and 2, the control unit 70 is a controller that controls the differential moving device 2. The control unit 70 is electrically connected to each of the components of the differential moving device 2 and controls the operation of each component. The control unit 70 controls the first driving motor 14, the second driving motor 16, and the like, The control unit 70 includes a general-purpose processor such as a CPU, an MPU, an FPOA, a DSP, or an ASIC that realizes a predetermined function by executing a program. The control unit 70 can realize various controls in the differential moving device 2 by calling and executing a control program stored in a memory. The control unit 70 is not limited to one that realizes a predetermined function by cooperation of hardware and software, and may be a hardware circuit designed exclusively for realizing a predetermined function.

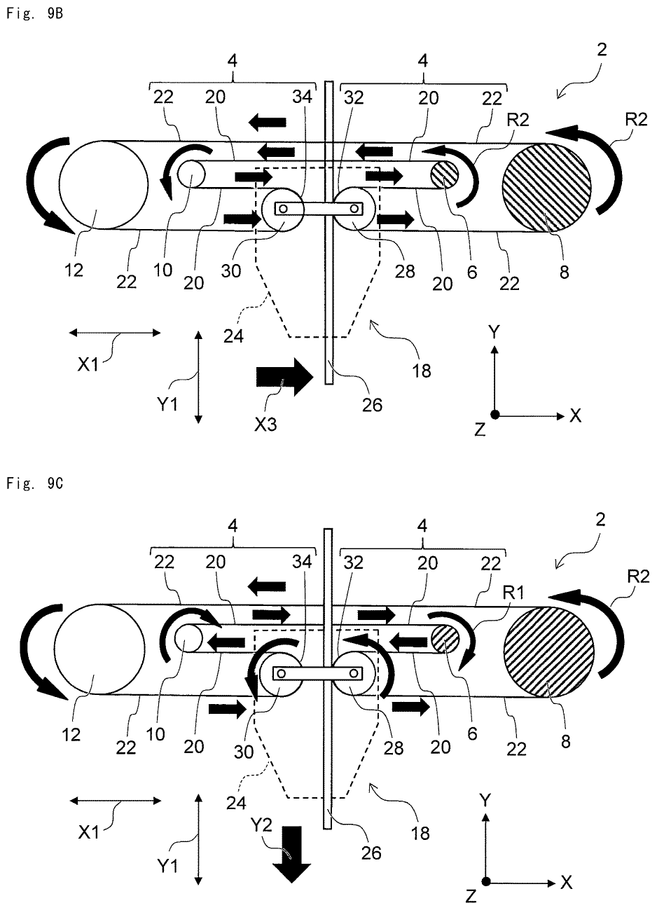

The operation of the differential moving device 2 having the above configuration will be described with reference to FIGS. 9A to 9D.

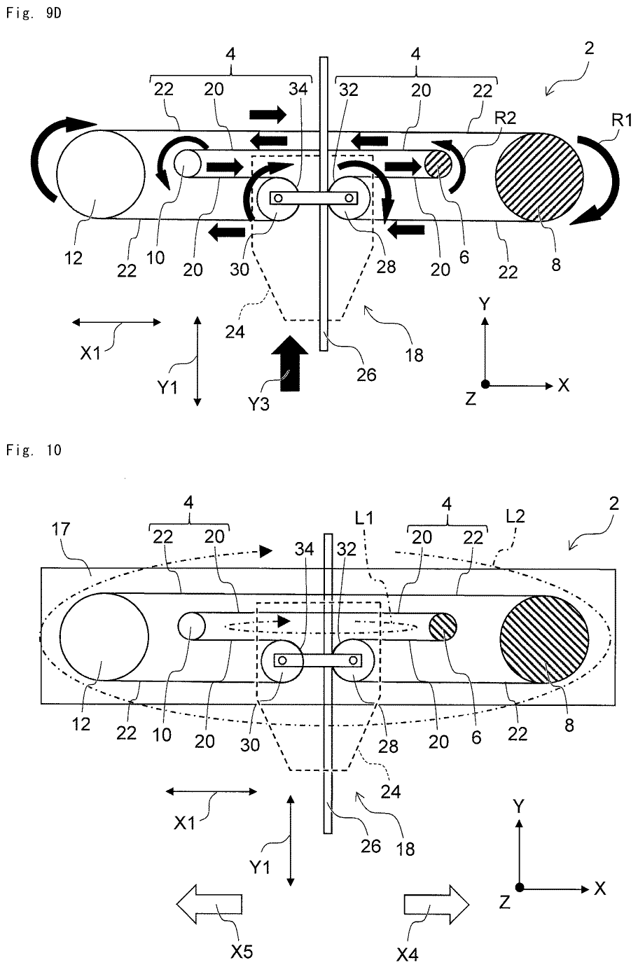

FIGS. 9A to 9D are schematic front views for describing the operation of the differential moving device 2 according to the first embodiment, and illustrate different states from each other. In FIGS. 9A to 9D, in order to distinguish the driving rollers and the driven rollers, the driving rollers 6 and 8 are hatched, and the driven rollers 10 and 12 are outlined. The same applies to FIG. 10 and subsequent drawings.

FIG. 9A illustrates a state in which the first driving roller 6 and the second driving roller 8 are rotationally driven in the same first rotation direction R1.

As illustrated in FIG. 9A, due to the rotation of the first driving roller 6 and the second driving roller 8, the path segments 20 and 22 of the endless member 4 move in the direction indicated by the straight arrows, and the driven rollers 10 and 12 each rotate in the direction indicated by the arc arrows.

FIG. 9A illustrates a case where a moving speed of the first path segment 20 and a moving speed of the second path segment 22 are the same.

In the first movable pulley 28, the first end of the first path segment 20 and the first end of the second path segment 22 will move in the same direction (left side in the drawing) along the first axial direction X1; therefore, a force that moves the first movable pulley 28 in such a direction acts. In the second movable pulley 30, the second end of the first path segment 20 and the second end of the second path segment 22 will move in the same direction (left side in the drawing) along the first axial direction X1; therefore, a force that moves the second movable pulley 30 in such a direction acts. Since both the movable pulleys 28 and 30 move in such a direction, the movable pulley unit 18 including the first moving block 24 and the second moving block 26 moves toward the left side in the drawing along the first axial direction X1 (arrow X2).

FIG. 9B illustrates a state in which the first driving roller 6 and the second driving roller 8 are rotationally driven in the same second rotation direction R2. The second rotation direction R2 is opposite to the first rotation direction R1 illustrated in FIG. 9A.

As illustrated in FIG. 9B, due to the rotation of the first driving roller 6 and the second driving roller 8, the path segments 20 and 22 of the endless member 4 move in the direction indicated by the straight arrows, and the driven rollers 10 and 12 each rotate in the direction indicated by the are arrows. Similarly, FIG. 9B illustrates a case where the moving speed of the first path segment 20 and the moving speed of the second path segment 22 are the same.

In the first movable pulley 28, the first end of the first path segment 20 and the first end of the second path segment 22 will move in the same direction (right side in the drawing) along the first axial direction X1; therefore, a force that moves the first movable pulley 28 in such a direction acts, and a force in such a direction also acts in the second movable pulley 30. As a result, the movable pulley unit 18 including the first moving block 24 and the second moving block 26 integrally moves toward the right side in the drawing along the first axial direction X1 (arrow X3).

As described above, by rotating the driving rollers 6 and 8 in the same rotation direction and moving the path segments 20 and 22 at the same speed, the movable pulley unit 18 can be slidingly moved along the first axial direction X1 (towing mode).

FIG. 9C illustrates a state in which the first driving roller 6 is rotationally driven in the first rotation direction R1 and the second driving roller 8 is rotationally driven in the second rotation direction R2 that is opposite to the first rotation direction R1. Similarly, Pig. 9C illustrates a case where the moving speed of the first path segment 20 and the moving speed of the second path segment 22 are the same.

In the first movable pulley 28, the first end of the first path segment 20 moves toward the left side in the drawing, but the first end of the second path segment 22 moves toward the right side in the drawing. Therefore, a force that rotates the first movable pulley 28 in the second rotation direction R2 acts. In the second movable pulley 30, the second end of the first path segment 20 moves toward the left side in the drawing, but the second end of the second path segment 22 moves toward the right side in the drawing. Therefore, a force that rotates the second movable pulley 30 in the second rotation direction R2 acts. As a result, the second moving block 26 engaged to the first movable pulley 28 moves downward in the drawing along the second axial direction Y1 with the rotation of the first movable pulley 28 (arrow Y2).

FIG. 9D illustrates a state in which the first driving roller 6 is rotationally driven in the second rotation direction R2, and the second driving roller & is rotationally driven in the first rotation direction R1 that is opposite to the second rotation direction R2. Similarly, FIG. 9D illustrates a case where the moving speed of the first path segment 20 and the moving speed of the second path segment 22 are the same.

In the first movable pulley 28, the first end of the first path segment 20 moves toward the right side in the drawing, but the first end of the second path segment 22 moves toward the left side in the drawing. Therefore, a force rotating the first movable pulley 28 in the first rotation direction R1 acts, and a force rotating in such a direction also acts on the second movable pulley 30. As a result, the second moving block 26 engaged to the first movable pulley 28 moves upward in the drawing along the second axial direction Y1 with the rotation of the first movable pulley 28 (arrow Y3).

As described above, by rotating the driving rollers 6 and 8 in opposite rotation directions and moving the path segments 20 and 22 at the same speed, the second moving block 26 of the movable pulley unit 18 can be slidingly moved along the second axial direction Y1 (circulating mode).

FIGS. 9A to 9D have exemplified the case where the moving speed of each of the path segments 20 and 22 is the same, but the moving speeds of the path segments 20 and 22 may be different. As a result, the second moving block 26 of the movable pulley unit 18 can be two-dimensionally moved in the XY directions. By combining the towing mode illustrated in FIGS. 9A and 9B and the circulating mode illustrated in FIGS. 9C and 9D, the sliding movement of the first moving block 24 and the sliding movement of the second moving block 26 can be simultaneously generated.

In the towing mode illustrated in FIGS. 9A and 9B, by differentiating the moving speeds of the path segments 20 and 22, the movable pulleys 28 and 30 are slidingly moved, and, in addition, the movable pulleys 28 and 30 can be made to rotate. As a result, the first moving block 24 is moved in the first axial direction X1, and, in addition, the second moving block 26 can be moved in the second axial direction Y1.

In the circulating mode illustrated in FIGS. 9C and 9D, by differentiating the moving speeds of the path segments 20 and 22, the movable pulleys 28 and 30 are rotated, and, in addition, the movable pulleys 28 and 30 can be slidingly moved. As a result, the second moving block 26 is moved in the second axial direction Y1, and, in addition, the first moving block 24 can be moved in the first axial direction X1.

The control unit 70 illustrated in FIGS. 1 and 2 can move the movable pulley unit 18 along the X direction and the Y direction at arbitrary speed components by controlling the rotation direction and the rotation speed (moving speeds of path segments 20 and 22) of each of the driving rollers 6 and 8. As a result, it is possible to move a work member (not shown) to an arbitrary position on an XY plane and to perform a desired work in a state where the work member is attached to a tip end of the second moving block 26.

Since the second moving block 26 of the first embodiment has a cantilever structure, a degree of freedom of installation layout is high unlike a structure using parallel beams such as an H-shaped frame.

In the differential moving device 2 of the first embodiment, in particular, since no motor is mounted on the movable pulley unit 18, which is a movable portion, a peripheral configuration including the movable pulley unit 18 can be reduced in weight and simplified, thereby contributing to an increase in speed of the movable portion and a reduction in capacity of the driving motors 14 and 16. As a result, this contributes to downsizing and weight reduction of the supporting block 17.

FIG. 10 is a front view roughly illustrating a main part of the differential moving device 2 of the first embodiment.

As illustrated in FIG. 10, in the endless member 4, the first path segment 20 disposed in the inside constitutes a first loop L1 (inner loop), and the second path segment 22 disposed on the outside constitutes a second loop L2. Since the endless member 4 constitutes the first loop L1 in the inside and the second loop L2 on the outside, it is possible to reduce a dimension of the differential moving device 2 in the XY directions and to achieve downsizing as compared with, for example, a structure using an H-shaped frame.

In this configuration, the first driving roller 6 and the first driven roller 10 are disposed inside the first loop L1, and the second driving roller 8 and the second driven roller 12 are disposed inside the second loop L2. As a result, the dimension in the XY directions of the differential moving device 2 can be further reduced, and further downsizing can be achieved.

In this configuration, the driving rollers 6 and 8 are disposed on a first side with respect to the movable pulley unit 18 (arrow X4), and the driven rollers 10 and 12 are disposed on a second side with respect to the movable pulley unit 18 (arrow X5). In particular, by disposing the driving rollers 6 and & on the same side (arrow X4), it is possible to provide a structure in which the driving motors 14 and 16 having a large weight illustrated in FIGS. 1 and 2 are gathered on one side. With such an arrangement, it is possible to dispose the motors in a concentrated manner, and, for example, in a case where the device is rotated clockwise by 90° from the angle illustrated in FIG. 10 such that the driving rollers 6 and S are disposed on the lower side, it is possible to bring a center of gravity of the entire device downward and to stabilize the device as a structure. In this case, the device is suitable for a self-propelled harvesting robot or the like having a risk of tumbling, and can also be applied to an elevator or an automated warehouse. In addition, by disposing the driving motors 14 and 16 in a concentrated manner, it is possible to concentrate wires connected to the driving motors 14 and 16 and to thereby improve handling.

Furthermore, in the circulating mode illustrated in FIGS. 9C and 9D, by using the second moving block 26 as a track, the components of the differential moving device 2 except the second moving block 26 (such as the first moving block 24 and the supporting block 17) can also be used as a traveling device having a position adjustment function in a direction orthogonal to the track (for example, X direction).

### Operation and Effect

As described above, the differential moving device 2 according to the first embodiment includes: the endless member 4 constituting an endless path, the endless member 4 including: the first path segment 20 disposed inside; the second path segment 22 disposed outside, and the connection path segment 32, 34 connecting the first path segment 20 and the second path segment 22; the first driving roller 6 engaged to the first path segment 20; the second driving roller 8 engaged to the second path segment 22; the first driving motor 14 that rotationally drives the first driving roller 6; the second driving motor 16 that rotationally drives the second driving roller 8; the control unit 70 that controls the first driving motor 14 and the second driving motor 16; and the movable pulley unit 18 engaged to the connection path segment 32, 34, the movable pulley unit 18 including: the movable pulleys 28 and 30 that linearly move along the first axial direction X1 and/or rotates with movement of the first path segment 20 and the second path segment 22; the first moving block 24 (first moving member) that moves along the first axial direction X1 with linear movement of the movable pulleys 28 and 30; and the second moving block 26 (second moving member) that is held by the first moving block 24 and moves with rotation of the movable pulley 28.

With such a configuration, in the differential moving device 2, the sizes of the endless member 4 and the supporting block 17 can be reduced, thereby achieving downsizing.

Further, in the differential moving device 2 of the first embodiment, the second moving block 26 (second moving member) linearly moves along the second axial direction Y1 with the rotation of the movable pulley 28. Such a configuration can achieve a differential moving device 2 having a function of two-axis movement.

Further, in the differential moving device 2 of the first embodiment, the first axial direction X1 and the second axial direction Y1 extend in directions intersecting (orthogonal to) each other. Such a configuration enables the first moving block 24 and the second moving block 26 to move in different directions from each other. The first axial direction and the second axial direction do not need to be orthogonal to each other. and may intersect at an angle different from 90 degrees.

Furthermore, in the differential moving device 2 of the first embodiment, (i) the connection path segments 32 and 34 include: the first connection path segment 32 that connects the first end of the first path segment 20 and the first end of the second path segment 22; and the second connection path segment 34 that connects the second end of the first path segment 20 and the second end of the second path segment 22, (ii) the movable pulleys 28 and 30 include: the first movable pulley 28 engaged to the first connection path segment 32; and the second movable pulley 30 engaged to the second connection path segment 34, and (iii) the first movable pulley 28 and the second movable pulley 30 integrally move along the first axial direction X1. With such a configuration, by providing the two movable pulleys 28 and 30, it is easy to realize a desired operation of the differential moving device 2.

Furthermore, in the differential moving device 2 of the first embodiment, the second moving block 26 is engaged with only the first movable pulley 28 of the first movable pulley 28 and the second movable pulley 30. With such a configuration, when the first movable pulley 28 and the second movable pulley 30 rotate in the same rotation direction, the movements of the first movable pulley 28 and the second movable pulley 30 do not interfere with each other, so that the second moving block 26 can be moved along the second axial direction Y1.

Note that the present invention is not limited only to the case where the second moving block 26 is engaged only with the first movable pulley 28 but may include a case where the second moving block 26 is engaged only with the second movable pulley 30. In that case, the gear 56 illustrated in FIG. 7 may be provided on the second movable pulley 30. That is, the second moving block 26 may be engaged with any one of the first movable pulley 28 and the second movable pulley 30.

Furthermore, the differential moving device 2 of the first embodiment further includes the supporting block 17 that supports the first driving roller 6 and the second driving roller & each in a r table stat e. Such a configuration makes it possible to stabilize the operation of the driving rollers 6 and 8 and to design the supporting block 17 to be small in size.

Furthermore, in the differential moving device 2 of the first embodiment, the supporting block 17 includes the first guide portion 40 that guides the movement of the first moving block 24 along the first axial direction X1. Such a configuration can stabilize an operation of the first moving block 24.

In the differential moving device 2 of the first embodiment, the first moving block 24 includes the second guide portion 41 that guides the movement of the second moving block 26 along the second axial direction Y1. Such a configuration can stabilize an operation of the second moving block 26.

In the differential moving device 2 of the first embodiment, the first driving roller 6 is disposed inside the first path segment 20, and the second driving roller 8 is disposed inside the second path segment 22. Such a configuration makes it easy to further downsize the endless member 4.

Furthermore, in the differential moving device 2 of the first embodiment, the endless member 4 includes: the first main surface to which the first driving roller 6 is engaged; and the second main surface to which the second driving roller 8 is engaged. Such a configuration improves the degree of freedom in installation of the driving rollers 6 and 8 engaged to the endless member 4, so that it is easy to further downsize.

Furthermore, in the differential moving device 2 of the first embodiment, the first driving roller 6 and the second driving roller 8 are disposed on a first side (arrow X4 in FIG. 10) with respect to the movable pulley unit IS. Such a configuration makes it possible to concentrate the weights of the driving rollers 6 and 8, the driving motors 14 and 16, and the like.

Furthermore, the differential moving device 2 of the first embodiment includes: the first driven roller 10 engaged to the first path segment 20; and the second driven roller 12 engaged to the second path segment 22. Such a configuration can more stabilize the operation of the endless member 4.

Furthermore, in the differential moving device 2 of the first embodiment, the first driving roller 6 and the first driven roller 10 are disposed inside the first path segment 20, and the second driving roller 8 and the second driven roller 12 are disposed inside the second path segment 22. Such a configuration makes it easy to further downsize the endless member 4.

Furthermore, in the differential moving device 2 of the first embodiment, the endless member 4 is at least one of a belt, a chain, a wire, a cable, a rope, and a thread. Such a configuration makes it possible to use various endless members 4.

### Various variations

Hereinafter, various variations of the first embodiment will be described. The configurations that are the same as or similar to those in the first embodiment will be described with the same names and reference signs, and descriptions redundant to those in the first embodiment will be appropriately omitted.

### First to Third Variations

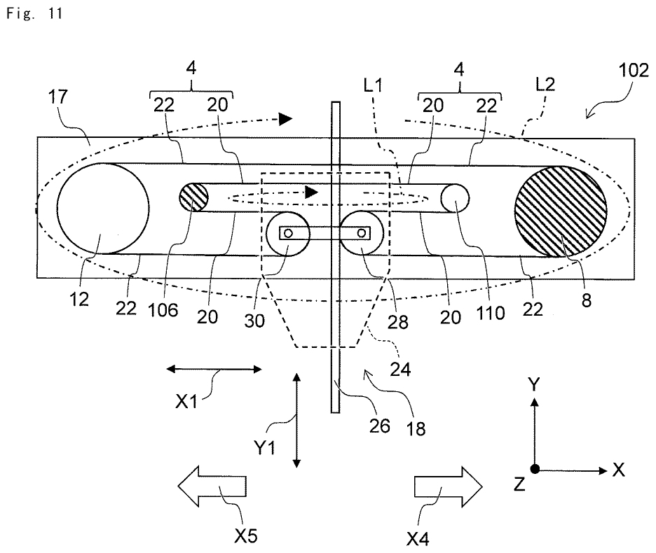

In the first embodiment, the case has been described in which the driving rollers 6 and 8 and the driven rollers 10 and 12 are disposed in the layout illustrated in FIG. 10. However, such a layout is not restrictive, and any layout may be adopted as long as an inner loop L1 and an outer loop L2 are formed and at least one driving roller is engaged to each of the loops L1 and L2. Such a variation will be described with reference to FIGS. 11 to 13.

FIG. 11 is a front view roughly illustrating a main part of a differential moving device 102 according to a first variation.

In the differential moving device 102 illustrated in FIG. 11, the second driving roller 8 and the second driven roller 12 constituting the outer loop L2 are disposed in the same manner as the first embodiment, however, a first driving roller 106 and a first driven roller 110 constituting the inner loop L1 are differently disposed from those in the first embodiment.

In the example illustrated in FIG. 11, the positions of the first driving roller 6 and the first driven roller 10 are exchanged, a first driving roller 106 is disposed on the same side (arrow X5) as the second driven roller 12, and a first driven roller 110 is disposed on the same side (arrow X4) as the second driving roller 8.

Even in such a disposition and layout, the control unit 70 controls rotation directions and rotation speeds of driving rollers 8 and 106, so that the same operation as that of the differential moving device 2 of the first embodiment can be performed.

With the differential moving device 102 according to the first variation, the first driving roller 106 and a first driving motor (not illustrated) connected to the first driving roller are disposed on a first side (arrow X5) with respect to the movable pulley unit 18, and the second driving roller 8 and a second driving motor (not illustrated) connected to the second driving roller S are disposed on a second side (arrow X4) with respect to the movable pulley unit 18. As a result, the weights of the plurality of driving rollers and the plurality of driving motors can be distributed.

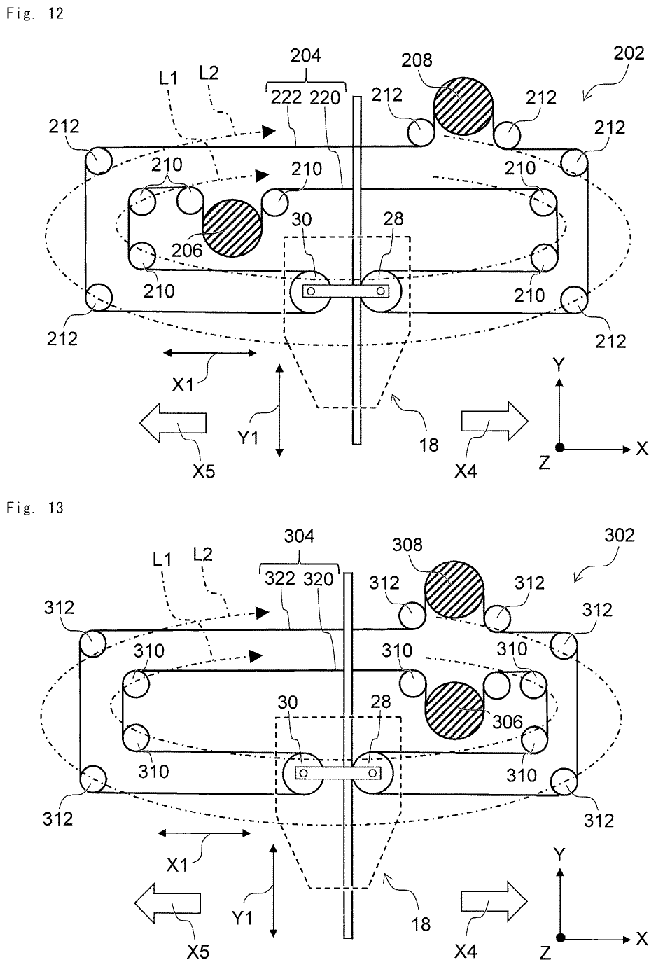

FIG. 12 is a front view roughly illustrating a main part of a differential moving device 202 according to a second variation.

The differential moving device 202 illustrated in FIG. 12 includes an endless member 204, and the endless member 204 includes: a first path segment 220 constituting the inner loop L1; and a second path segment 222 constituting the outer loop L2.

One first driving roller 206 and a plurality of first driven rollers 210 are engaged to the inner loop L1. One second driving roller 208 and a plurality of second driven rollers 212 are engaged to the outer loop L2.

In the example illustrated in FIG. 12, the second driving roller 208 is disposed on a first side (arrow X4), and the first driving roller 206 is disposed on a second side (arrow X5).

Even in such a disposition and layout, the control unit 70 controls rotation directions and rotation speeds of the driving rollers 206 and 208, so that the same operation as that of the differential moving device 2 of the first embodiment can be performed.

In the differential moving device 202 according to the second variation, the first driving roller 206 and the second driving roller 208 are engaged with the same main surface of the two main surfaces of the endless member 204. Since it is not necessary that both of the o main surfaces of the endless member 204 can be engaged to the driving roller, it is possible to use an endless member in which only one main surface can be engaged to the driving roller, for example, a single-sided timing belt can be used. As a result, the endless member 204 in a broader range can be used.

FIG. 13 is a front view roughly illustrating a main part of a differential moving device 302 according to a third variation.

The differential moving device 302 illustrated in FIG. 13 includes an endless member 304, and the endless member 304 includes: a first path segment 320 constituting the inner loop L1; and a second path segment 322 constituting the outer loop L2.

One first driving roller 306 and a plurality of first driven rollers 310 are engaged to the inner loop L1. One second driving roller 308 and a plurality of second driven rollers 312 are engaged to the outer loop L2.

In the example illustrated in FIG. 13, both the first driving roller 306 and the second driving roller 308 are disposed on a first side (arrow X4).

Even in such a disposition and layout, the control unit 70 controls rotation directions and rotation speeds of the driving rollers 306 and 308, so that the same operation as that of the differential moving device 2 of the first embodiment can be performed.

Similarly, in the differential moving device 302 according to the third variation, since the driving rollers 306 and 308 are engaged with the same main surface of the two main surfaces of the endless member 304, a single-sided timing belt or the like can be used.

As described above, with the configuration in which the endless member 4 includes the inner loop L1 and the outer loop L2, the driving rollers and the driving motors can be disposed in a concentrated manner as in the first embodiment and the third variation, or can be disposed in a distributed manner as in the first and second variations. As described above, it is possible to realize a design in consideration of so-called mass distribution. When the H-shaped frame is used as in Patent Document 1, it is necessary to dispose a driving motor at any of the four end portions of the H-shaped frame, and there is a large restriction in disposition of the motor; therefore, it is difficult to realize a design in consideration of mass distribution, which fact differentiates the case of using an H-shaped frame from the invention of the present disclosure.

### Fourth and Fifth Variations

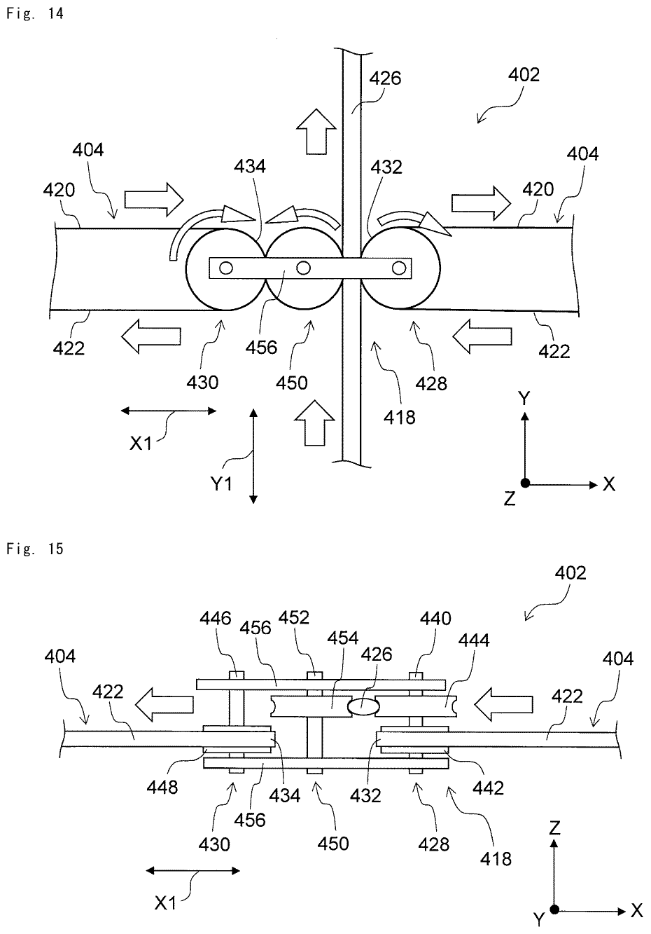

As illustrated in FIG. 10 and the like, the first embodiment has described the case where a rack and pinion is used in which the first movable pulley 28 of the movable pulley unit 18 is a pinion gear and the second moving block 26 is a rack; however, the present invention does not need to have such a structure. Such a variation will be described with reference to FIGS. 14 to 17.

FIG. 14 is a front view roughly illustrating a main part of a differential moving device 402 according to a fourth variation, and FIG. 15 is a bottom view of a main part of the differential moving device 402 illustrated in FIG. 14 as viewed from below.

The differential moving device 402 illustrated in FIGS. 14 and 15 includes an endless member 404, and the endless member 404 includes a first path segment 420, a second path segment 422, a first connection path segment 432, and a second connection path segment 434.

A movable pulley unit 418 includes a first movable pulley 428, a second movable pulley 430, and a third movable pulley 450. The first movable pulley 428 is engaged to the first connection path segment 432, and the second movable pulley 430 is engaged to the second connection path segment 434. The third movable pulley 450 is disposed between the first movable pulley 428 and the second movable pulley 430.

The movable pulley unit 418 further includes a coupling plate 456 for rotatably coupling the three movable pulleys 428, 430, and 450.

As illustrated in FIG. 15, the first movable pulley 428 includes a rotating shaft 440, a gear 442, and a roller 444. The rotating shaft 440 integrally pivotally supports the gear 442 and the roller 444, and integrally rotates the gear 442 and the roller 444. The gear 442 is engaged to the first connection path segment 432 and rotates in accordance with movement of the endless member 404. The roller 444 is engaged with a second moving block 426.

The second movable pulley 430 includes a rotating shaft 446 and a gear 448. The rotating shaft 446 pivotally supports the gear 448. The gear 448 is engaged to the second connection path segment 434 and rotates in accordance with the movement of the endless member 404.

The third movable pulley 450 includes a rotating shaft 452 and a roller 454. The rotating shaft 452 pivotally supports a roller 454, and the roller 454 is engaged with the second moving block 426.

The second moving block 426 is sandwiched between the roller 444 of the first movable pulley 428 and the roller 454 of the third movable pulley 450. When the movable pulleys 428 and 430 rotate with the movement of the endless member 4, the rollers 44 of the first movable pulley 428 rotate, so that the second moving block 426 slidingly moves along the second axial direction Y1 as illustrated in FIG. 14. The roller 454 rotates following the movement of the second moving block 426.

With the above configuration, the second moving block 426 is slidingly movable along the second axial direction Y1 while being sandwiched between the two rollers 444 and 454 and not falling off due to friction with the two rollers 444 and 454.

With the above configuration, the second moving block 426 can be slidingly moved by using a structure different from a rack and pinion, and can be used as a structure for sending any type of wire rod.

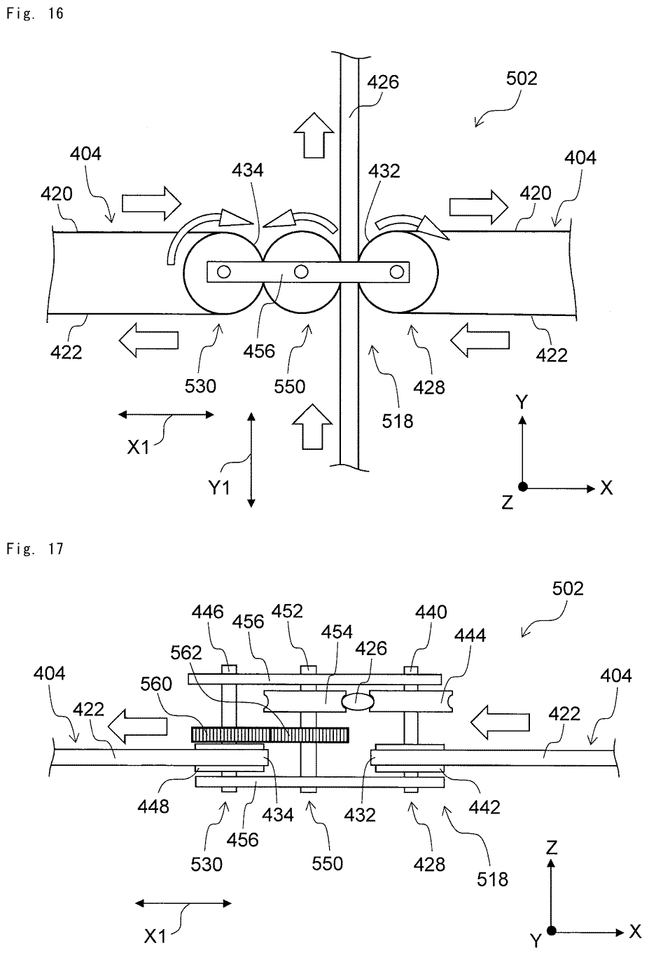

FIG. 16 is a front view roughly illustrating a main part of a differential moving device 502 according to a fifth variation, and FIG. 17 is a bottom view of a main part of the differential moving device 502 illustrated in FIG. 16 as viewed from below.

The differential moving device 502 of the fifth variation illustrated in FIG. 16 is different from the differential moving device 402 of the fourth variation illustrated in FIGS. 14 and 15 in a configuration of a movable pulley unit 518.

The movable pulley unit 518 illustrated in FIGS. 16 and 17 Includes the first movable pulley 428, a second movable pulley 530, and a third movable pulley 550.

As illustrated in FIG. 17, the second movable pulley 530 further includes a gear 560 in addition to the rotating shaft 446 and the gear 448. The third movable pulley 550 further includes a gear 562 in addition to the rotating shaft 452 and the roller 454.

The gear 560 and the gear 562 mesh with each other. The gear 360 is configured to rotate integrally with the gear 448, and the gear 562 rotates in the reverse rotation direction in accordance with the rotation of the gear 560. When the gear 448 and the gear 560 integrally rotate in accordance with the movement of the endless member 404. the gear 562 meshing with the gear 560 and the roller 454 integrally rotate in the reverse rotation direction.

With the above configuration, the second moving block 426 is not only fed in the second axial direction Y1 by the roller 444 of the first movable pulley 428 but also fed in the same direction by the roller 454 of the third movable pulley 550 (FIG. 16). Not only a rotation force of the first movable pulley 428 is transmitted, but a rotation force of the second movable pulley 530 is transmitted to the second moving block 426 via the gears 560 and 562, so that a driving force for the second moving block 426 can be increased.

### Sixth Variation

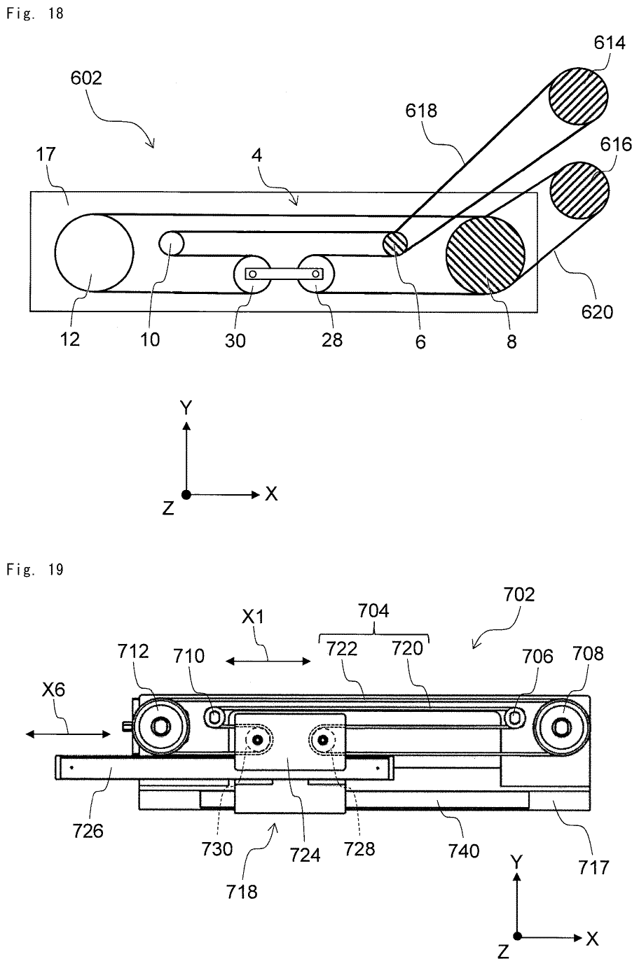

As illustrated in FIGS. 1 and 2, the first embodiment has described the case where the driving motors 14 and 16 are directly connected to the driving rollers 6 and 8; however, the present invention is not limited to such a case. Such a variation will be described with reference to FIG. 18.

FIG. 18 is a front view roughly illustrating a main part of a differential moving device 602 according to a sixth variation.

The differential moving device 602 illustrated in FIG. 18 includes a first driving motor 614 for driving the first driving roller 6 and a second driving motor 616 for driving the second driving roller 8.

The driving motors 614 and 616 are not directly connected to the driving rollers 6 and 8, but are indirectly connected to the driving rollers 6 and 8 via endless members 618 and 620, respectively.

The endless member 618 rotatably connects the first driving roller 6 and the first driving motor 614, and the endless member 620 rotatably connects the second driving roller 8 and the second driving motor 616. Any type of endless members 618 and 620 may be used as long as each endless member can rotatably engage a driving roller and a driving motor.

With the above configuration, since the driving motors 614 and 616 are separated from the driving rollers 6 and 8 and the supporting block 17, the degree of freedom of disposition of the driving motors 614 and 616 is increased, and the dimension of the differential moving device 602 in the Z direction can be reduced. As a result, for example, in a case where a plurality of the differential moving devices 602 are used while being arranged at intervals in the Z direction, the plurality of differential moving devices 602 can be disposed more densely, and it is possible to realize a dense multi-row arrangement. In this case, for example, in an applications such as a picking machine, it is possible to perform parallel processing of tasks, which contributes to improvement in processing capacity per device installation area and in speed-up.

### Second Embodiment

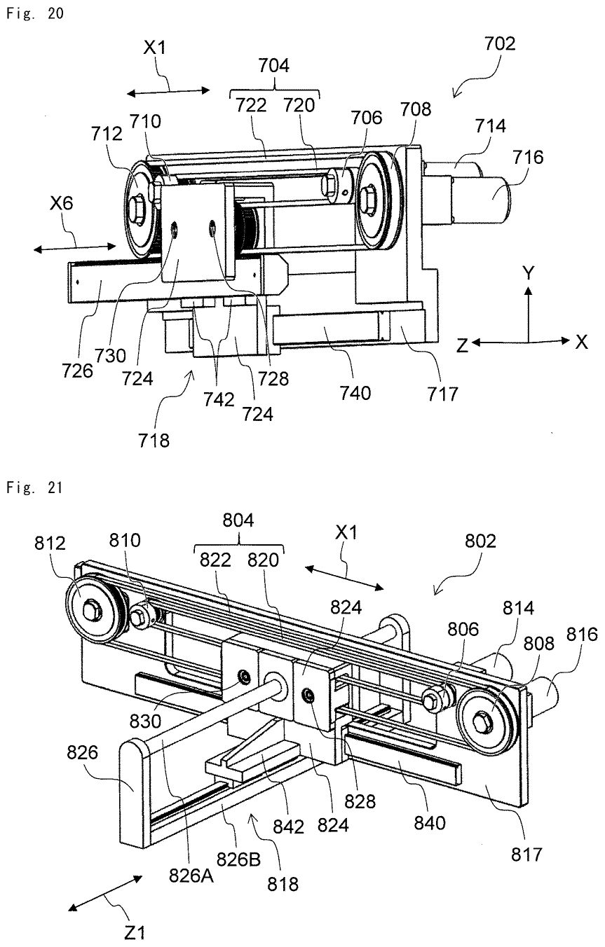

With reference to FIGS. 19 and 20, a differential moving device 702 according to a second embodiment will be described.

FIG. 19 is a front view of the differential moving device 702 according to the second embodiment, and FIG. 20 is a perspective view of the differential moving device 702 according to the second embodiment.

In the first embodiment, the two axes on which the movable pulley unit 18 moves intersect each other (the first axial direction X1 and the second axial direction Y1); however, the second embodiment is different in that the two axes on which a movable pulley unit 718 moves are parallel to each other (a first axial direction X1 and a second axial direction X6).

The differential moving device 702 illustrated in FIGS. 19 and 20 includes an endless member 704, a first driving roller 706, a second driving roller 708, a first driven roller 710, a second driven roller 712, a first driving motor 714 (FIG. 20), a second driving motor 716, a supporting block 717, and a movable pulley unit 718.

The endless member 704 includes a first path segment 720 and a second path segment 722. The movable pulley unit 718 includes a first moving block 724, a second moving block 726, a first movable pulley 728, and a second movable pulley 730.

In the above configuration, the first moving block 724 is engaged with a first guide portion 740 provided on the supporting block 717 and extending in an X direction, and is slidingly movable in the first axial direction X1 along the first guide portion 740. The second moving block 726 is engaged with the first movable pulley 728 inside the first moving block 724 in a state of being held by the first moving block 724, and is movable in the second axial direction X6 with rotation of the first movable pulley 728.

As shown in FIG. 20, the first moving block 724 is provided with a second guide portion 742 extending in the X direction, and the second moving block 726 is engaged with the second guide portion 742 and is slidingly movable in the X direction along the second guide portion 742.

The second moving block 726 and the first movable pulley 728 of the second embodiment are configured in a rack and pinion arrangement, With the above configuration, the two axes on which the movable pulley unit 718 moves can be made to serve as the first axial direction X1 and the second axial direction X6 that are parallel to each other, and can be used in applications (for example, a telescopic mechanism) different from the differential moving device 2 of the first embodiment.

As described above, in the differential moving device 702 according to the second embodiment, the first axial direction X1 and the second axial direction X6 extend in directions parallel to each other. Such a configuration enables the differential moving device 702 to be used for applications different from those of the differential moving device 2 of the first embodiment.

### Third Embodiment

With reference to FIG. 21, a differential moving device 802 according to a third embodiment will be described.

FIG. 21 is a perspective view of the differential moving device 802 according to the third embodiment.

In the first embodiment, the two axes on which the movable pulley unit 18 moves are the first axial direction X1 and the second axial direction Y1; however, the third embodiment is different in that the two axes on which a movable pulley unit 818 moves are a first axial direction X1 and a second axial direction Z1.

The differential moving device 802 illustrated in FIG. 21 includes an endless member 804, a first driving roller 806, a second driving roller 808, a first driven roller 810, a second driven roller 812, a first driving motor 814, a second driving motor 816, a supporting block 817, and a movable pulley unit 818.

The endless member 804 includes a first path segment 820 and a second path segment 822. The movable pulley unit 818 includes a first moving block 824, a second moving block 826, a first movable pulley 828, and a second movable pulley 830.

In the above configuration, the first moving block 824 is engaged with a first guide portion 840 provided on the supporting block 817 and extending in an X direction, and slidingly moves in the first axial direction X1 along the first guide portion 840. The second moving block 826 is engaged with the first movable pulley 828 inside the first moving block 824 in a state of being held by the first moving block 824, and slidingly moves in the second axial direction Z1 with rotation of the first movable pulley 828.

The first moving block 824 is provided with a second guide portion 842 extending in a Z direction, and the second moving block 826 slidingly moves in the Z direction along the second guide portion 842.

The second moving block 826 illustrated in FIG. 21 includes a first rod-shaped portion 826A and a second rod-shaped portion 826B. The first rod-shaped portion 826A extends so as to penetrate the first moving block 824, and is engaged with the first movable pulley 828 inside the first moving block 824. The first rod-shaped portion 826A has a driving force conversion structure (for example, a ball screw structure) that converts a driving force in a rotation direction of the first movable pulley 828 into a driving force in the Z direction. The second rod-shaped portion 826B extends parallel to the first rod-shaped portion 826A and is engaged with the second guide portion 842 of the first moving block 824.

The movement along the two directions can be performed not only in the X direction and the Y direction in the first embodiment but also in the X direction and the Z. direction in the above configuration.

As described above, it is possible to achieve a differential moving device that is movable not only along the two axes orthogonal to each other but along two axes extending in arbitrary directions such as two axes intersecting at an angle different from 90 degrees or two axes parallel to each other as in the second embodiment.

### Fourth Embodiment

With reference to FIGS. 22 to 24, a differential moving device 902 according to a fourth embodiment will be described.

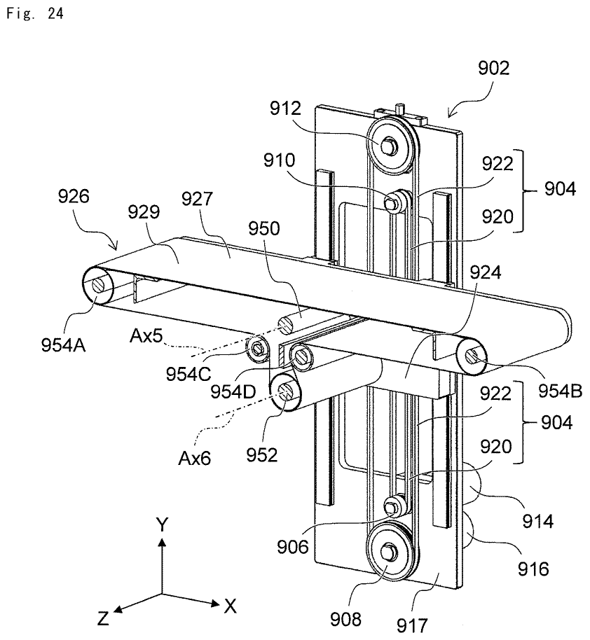

FIGS. 22 and 23 are perspective views of the differential moving device 902 according to the fourth embodiment. FIG. 24 is a perspective view obtained by performing cutting away on the differential moving device 902 of FIG. 22 along an I-I cross-section.

The first embodiment is the differential moving device 2 of a “two-axis type”, in which the first moving block 24 moves along the first axial direction and the second moving block 26 moves along the second axial direction. However, the fourth embodiment is different in that a moving block 924 as a first moving member moves along a first axial direction (Y-axis direction), and, on the other hand, a belt conveyor 926 as a second moving member rotationally moves a belt 927.

The differential moving device 902 illustrated in FIGS. 22 and 23 includes an endless member 904, a first driving roller 906, a second driving roller 908, a first driven roller 910, a second driven roller 912, a first driving motor 914, a second driving motor 916, a supporting block 917, and a movable pulley unit 918.

The endless member 904 includes a first path segment 920 constituting an inner loop and a second path segment 922 constituting an outer loop. The movable pulley unit 918 includes the moving block 924 (first moving member), the belt conveyor 926 (second moving member), a first movable pulley 928, and a second movable pulley 930.

The moving block 924 rotatably holds the first movable pulley 928 and the second movable pulley 930 illustrated in FIG. 23, and is engaged with guide portions 940A and 940B provided on the supporting block 917 illustrated in FIG. 22 and extending in a Y direction. The moving block 924 engaged with the guide portions 940A and 940B is slidingly movable (that is, movable up and down) along a first axial direction Y2 with movement of the first movable pulley 928 and the second movable pulley 930 in the Y direction.

The belt conveyor 926 is held by the moving block 924 and has an endless belt 927. The belt 927 is engaged to the second movable pulley 930 via a drive shaft 952 (FIG. 24) to be described later, and is rotationally driven with rotation of the second movable pulley 930 and the drive shaft 952. The belt 927 has a forward rotation function (arrow R1) and a reverse rotation function (arrow R2) in accordance with a rotation direction of the second movable pulley 930.

The belt 927 has a belt upper surface 929 for conveying a conveyance object (not illustrated). The belt upper surface 929 linearly moves along an X direction by the rotation of the belt 927 to convey the conveyance object in the X direction.

As illustrated in FIG. 24, two drive shafts 950 and 952 are provided inside the belt 927.

The drive shaft 950 is a shaft member engaged to the first movable pulley 928 illustrated in FIG. 23, and rotates integrally with the first movable pulley 928 about a rotation axis Ax5 extending in a Z direction. The drive shaft 952 is a shaft member engaged to the second movable pulley 930 illustrated in FIG. 23, and rotates integrally with the second movable pulley 930 about a rotation axis Ax6 extending in the Z direction.

The two drive shafts 950 and 952 are both pivotally supported to be rotatable by a first plate 960 of the belt conveyor 926 illustrated in FIG. 22 and a second plate 962 of the belt conveyor 926 illustrated in FIG. 23. That is, both end portions of each of the drive shafts 950 and 952 are supported.

In the fourth embodiment, the drive shaft 950 is not engaged with the belt 927, but the drive shaft 952 is engaged with the belt 927. The drive shaft 952 engaged with the belt 927 functions as a drive pulley that transmits a rotational driving force to the belt 927 In the example illustrated in FIG. 24, the drive shaft 950 is configured with one shaft, but the drive shaft 952 is configured with one shaft and a cylindrical member surrounding a periphery of the shaft. The cylindrical member of the drive shaft 952 is engaged with an inner peripheral surface of the belt 927 by a predetermined length along a rotation direction.

Four idler pulleys 954A to 954D are further engaged with the belt 927.

Each of the four idler pulleys 954A to 954D is a pulley that rotates following the rotation of the belt 927. Every of the idler pulleys 954A to 954D is pivotally supported to be rotatably by the first plate 960 illustrated in FIG. 22 and the second plate 962 illustrated in FIG. 23, and both end portions of each of the idler pulleys 954A to 954D are supported similarly to the drive shafts 950 and 952, The idler pulleys 954A and 954B provided in an upper stage are engaged with the inner peripheral surface of the belt 927 at both end portions of the belt 927 in the X direction. The idler pulleys 954C and 954D provided in a lower stage are engaged with the outer peripheral surface of the belt 927 at a central part of the belt 927 in the X direction.

The differential moving device 902 having the above configuration is used in a posture in which the belt upper surface 929 of the belt 927 faces vertically upward. The belt conveyor 926 has a lifting function of moving up and down along the first axial direction Y2 and a rotating function of rotating the belt 927 endlessly. In a posture when the differential moving device 902 is used, the drive shaft 950 is disposed above the drive shaft 952.

The drive shaft 950 disposed upward supports a main part of the belt conveyor 926 including the two plates 960 and 962, and is a portion that receives a large load when the belt conveyor 926 moves up and down. In view of this fact, the drive shaft 950 is configured not to be engaged with the belt 927 and is configured such that both ends of the drive shaft 950 are supported by the two plates 960 and 962, so that the drive shaft can function as a portion that mainly receives a load at the time of moving up and down. As a result, strength of the differential moving device 902 can be improved. Note that in a case where sufficient rigidity can be secured, the drive shaft 950 may be omitted, and, instead of the drive shaft 950, the second plate 962 may mainly receive a load at the time of moving up and down.

The drive shaft 952 disposed downward is a portion that is less likely to receive a load at the time of moving up and down of the belt conveyor 926 as compared with the drive shaft 950, and the drive shaft 952 efficiently exerts a force for rotationally driving the belt 927 when being engaged with the belt 927 and functioning as a drive pulley.

As described above, considering different configurations and functions of the two drive shafts 950 and 952, it is possible to improve the strength of the differential moving device 902 by using the drive shaft 950, and, at the same time, it is possible to efficiently operate the belt conveyor 926 by using the drive shaft 952.

In the differential moving device 902 of the fourth embodiment, in particular, since a motor is not mounted on the movable pulley unit 918 serving as a movable portion, a peripheral configuration including the movable pulley unit 918 can be reduced in weight and simplified, thereby contributing to an increase in speed of the movable portion and a reduction in capacity of the driving motors 914 and 916. As a result, this contributes to downsizing and weight reduction of the supporting block 917.

As described above, the differential moving device 902 of the fourth embodiment includes the movable pulley unit 918 that includes: the movable pulleys 928 and 930 that linearly move along the first axial direction Y2 and/or rotate with the movement of the first path segment 920 and the second path segment 922; the moving block 924 (first moving member) that moves along the first axial direction Y2 with the linear movement of the movable pulleys 928 and 930; and the belt conveyor 926 (second moving member) that is held by the moving block 924 and moves with the rotation of the second movable pulley 930.

With such a configuration, in the differential moving device 902, the sizes of the endless member 904 and the supporting block 917 can be reduced, thereby achieving downsizing.

In the differential moving device 902 of the fourth embodiment, the second moving member is the belt conveyor 926 having the belt 927 that rotates with the rotation of the second movable pulley 930. Such a configuration can realize the belt conveyor 926 having a function of moving up and down along the first axial direction Y2 and a function of rotating the belt 927, and can realize the differential moving device 902 including the belt conveyor 926.

In the above, the present disclosure has been described with reference to the above-described first to fourth embodiments and first to sixth variations, but the present disclosure is not limited thereto.

For example, in the above-described embodiments and variations, the year is exemplified as the member engaged to the endless member 4, but the present invention is not limited to such a case. Depending on the type of the endless member 4, the endless member 4 may be driven by being engaged with a different type of member that is not a gear. For example, when the endless member 4 is a timing belt, a timing pulley may be engaged, when the endless member 4 is a chain, a sprocket may be engaged, and when the endless member 4 is a wire, a pulley or a sheave may be engaged.

Furthermore, the above-described embodiment and variations have exemplified the case where the control unit 70 as the controller controls the differential moving device 2, but the present invention is not limited to such a case, and a mechanical control means may be used instead of the controller.

When arbitrary embodiments and variations among the above-described embodiments and various variations are appropriately combined, their respective effects can be exhibited.

Although the present disclosure has been fully described in relation to preferred embodiments with reference to the accompanying drawings, various variations and modifications will be apparent to those skilled in the art. Such variations and modifications should be understood to be within the scope of the present disclosure unless the variations and the modifications depart from the scope of the present disclosure as set forth in the appended claims. In addition, combinations of elements and changes in order in each embodiment can be realized without departing from the scope and spirit of the present disclosure.

### INDUSTRIAL APPLICABILITY

The present disclosure is applicable to any differential moving device.

### REFERENCE SIGNS LIST

2 Differential moving device
4 Endless member
6 First driving roller
8 Second driving roller
10 First driven roller
12 Second driven roller
14 First driving motor
16 Second driving motor
18 Movable pulley unit
20 First path segment
22 Second path segment
24 First moving block (first moving member)
26 Second moving block (second moving member)
28 First movable pulley
30 Second movable pulley
32 First connection path segment
34 Second connection path segment
70 Control unit
X1 First axial direction
Y1 Second axial direction

1. A differential moving device comprising:
an endless member constituting an endless path, the endless member including:
a first path segment disposed inside; a second path segment disposed outside; and a connection path segment connecting the first path segment and the second path segment;
a first driving roller engaged to the first path segment;
a second driving roller engaged to the second path segment;
a first driving motor that rotationally drives the first driving roller;
a second driving motor that rotationally drives the second driving roller;
a control unit that controls the first driving motor and the second driving motor; and
a movable pulley unit including: a movable pulley that is engaged to the connection path segment and linearly moves along a first axial direction and/or rotates with movement of the first path segment and the second path segment; a first moving member that moves along the first axial direction with linear movement of the movable pulley; and a second moving member that is held by the first moving member and moves with rotation of the movable pulley.

2. The differential moving device according to claim 1, wherein
the second moving member linearly moves along a second axial direction with the rotation of the movable pulley,

3. The differential moving device according to claim 2, wherein
the first axial direction and the second axial direction extend in directions intersecting each other.

4. The differential moving device according to claim 2, wherein
the first axial direction and the second axial direction extend in directions parallel to each other.

5. The differential moving device according to claim 1, wherein
the second moving member rotationally moves with the rotation of the movable pulley.

6. The differential moving device according to claim 5, wherein
the second moving member is a belt conveyor having a belt that rotates with the rotation of the movable pulley.

7. The differential moving device according to claim 1, wherein
the connection path segment includes: a first connection path segment that connects a first end of the first path segment and a first end of the second path segment; and a second connection path segment that connects a second end of the first path segment and a second end of the second path segment,
the movable pulley includes: a first movable pulley engaged to the first connection path segment; and a second movable pulley engaged to the second connection path segment, and
the first movable pulley and the second movable pulley integrally move along the first axial direction.

8. The differential moving device according to claim 7, wherein the second moving member is engaged with any one of the first movable pulley and the second movable pulley.

9. The differential moving device according to claim 1, further comprising
a support member that supports the first driving roller and the second driving roller each in a rotatable state.

10. The differential moving device according to claim 9, wherein
the support member includes a first guide portion that guides the movement of the first moving member along the first axial direction.

11. The differential moving device according to claim 10, wherein
the first moving member includes a second guide portion that guides the movement of the second moving member.

12. The differential moving device according to claim 1, wherein
the first driving roller is disposed inside the first path segment, and
the second driving roller is disposed inside the second path segment.

13. The differential moving device according to claim 1, wherein
the endless member includes: a first main surface to which the first driving roller is engaged; and a second main surface to which the second driving roller is engaged.

14. The differential moving device according to claim 1, wherein
the first driving roller and the second driving roller are disposed on a first side with respect to the movable pulley unit.

15. The differential moving device according to claim 1, wherein
the first driving roller is disposed on a first side with respect to the movable pulley unit, and
the second driving roller is disposed on a second side with respect to the movable pulley unit.
